(19) United States
(12) Patent Application Publication
(10) Pub. No.: US 2011/0049239 A1
(43) Pub. Date: Mar. 3, 2011

(54) METHOD FOR STORING AND CODING INFORMATION WITH RAMAN-ACTIVE SUBSTANCES

(76) Inventors: Igor V. Kukushkin, Moscow District (RU); Leonid V. Kulik, Moscow District (RU); Artyom L. Yukhin, Moscow District (RU); Andrei S. Zhuravlev, Volgograd (RU)

(21) Appl. No.: 12/764,035

(22) Filed: Apr. 20, 2010

Related U.S. Application Data
(60) Provisional application No. 61/171,026, filed on Apr. 20, 2009.

(51) Int. Cl. G06K 7/12; B41J 2/015; B82Y 15/00

(52) U.S. Cl. 235/454; 347/20; 977/948

(57) ABSTRACT

A method for storing and coding information which utilizes mixtures of metal nanoclusters with dyes and other Raman-active substances is disclosed. A method for reading and decoding the stored information by measuring the Raman spectra is also disclosed. To code and store information, a plurality of dots or markers, each consisting of a mixture of two or more Raman-active substances taken in different proportions, is applied on a on object. The number of substances in the mixture and the relative quantities of each substance in the mixture carry the information to coded by each dot. By scanning a sequence of dots on the object, information stored in the sequence can be read and decrypted. Surface enhanced Raman scattering associated with metal nanoclusters and large Raman cross section of colored Raman-active substances make it more feasible to detect the Raman signal from a single dot of a small size (up to the diffraction limit) on the millisecond time scale.

### BACKGROUND

Raman spectroscopy involves the interaction of light with matter. It is commonly used in chemistry to obtain specific information about the chemical bonds in molecules.

When a molecule is excited by a light beam, it undergoes a transition to an excited state. As a consequence, the molecular polarizability changes, which allows the light to scatter inelastically. The spectrum of inelastically scattered light consists of a set of narrow spectral bands of different intensities, each corresponding to one particular excited state. The amount of polarizability change associated with one excited state determines the Raman scattering intensity for the corresponding band, whereas the gap separating the band energy and the photon energy of the excitation beam defines the Raman shift.

By analyzing the frequencies and intensities of Raman signal, molecular chemical structure can be determined. The phenomenon of Raman scattering thus acts as a molecular fingerprint.

Raman spectroscopy may be used for studying physical properties of unknown chemical substances and for identification of known ones. However, spontaneous Raman scattering is extremely weak compared to Rayleigh (elastic) scattering. Therefore, a highly sophisticated experimental technique, time consuming operations, and specially trained technicians have long been considered necessary for Raman measurements, thus positioning Raman spectroscopy as an exclusively scientific method.

The past decade brought much technical and commercial advancement in the field of Raman spectroscopy. The development of highly sensitive detectors based on charge-coupled devices (“CCD”), compact diodes and solid state lasers, efficient notch and cut-edge filters, which cut-edge filters can be used in place of highly dispersive devices for removing the Rayleigh scattering, have advanced the development of compact inexpensive Raman portable instrumentation.

In addition, surface enhanced Raman scattering (“SERS”) substrates and colloids have increased the intensity of Raman scattering 10⁶ times (commercially available) and in special cases up to 10¹⁴ times (reported)(K. Kneipp, et al, Phys. Rev. Lett. 78, 1667 (1997), A. M. Michaels, et al, J. Am. Chem. Soc. 121, 9932 (1999)).

The scattering cross section of SERS active substances can be further enhanced when the excitation light has a frequency resonating with an electronic transition, which is known as surface enhanced resonance Raman scattering (SERRS). The proliferation of compact Raman spectral instrumentation as well as SERS and SERRS spectroscopic techniques have led to a variety of commercial applications, including chemical analysis, quality control measurement, environmental analysis, and identification of hazardous materials. More generally the realm of possible applications for Raman scattering has been restricted to the analyses and identification of chemical substances.

### SUMMARY OF THE INVENTION

The present invention provides a methodology for generating, applying, reading, and processing of coded sequences of dots or markers formed with Raman-active substances, reading such sequences with a Raman instrumentation, translating such sequences into corresponding sequences of Raman spectra, identifying each Raman spectra with a pre-calibrated mixture using a spectral database, translating a spectrum of mixture into a text symbol or a series of symbols by using a table that correlates Raman spectra with symbols.

The proposed methodology can be used for storing and reading protected information for a variety of materials, substances and subjects, which require to be protected from unauthorized access and alteration. For example, the methodology can be used to protect documents with watermarks, banknotes, traveler's cheques, bonds, commercial labels, barcodes, certificates, stamps, works of art, ownership documents, passports, various identity cards, driver licenses, credit cards, brand authentication labels, and the like.

Counterfeited printable documents that look indistinguishable from authentic ones can be easily manufactured with modern equipment and techniques, such as microprinted text, ultraviolet watermarks, optically variable devices such as holograms, 1- and 2-D barcodes, magnetic stripes, encoded numbers, and machine-readable zones. Counterfeit documents range in quality, but can be almost indistinguishable, especially to a naked eye, from authentic documents. Inability to ensure authenticity of such documents may have very serious implications.

Utilizing Raman spectral dimension to code information offers a much higher level of protection and reliability. While a good forgery may be indistinguishable from an authentic document to the naked eye, defeating the protection based on the method taught herein, it would be necessary to find out the combination of Raman-active substances used in the coding and, then, deciphering it would require a table with Raman spectra symbols that were used for coding.

Other advantages will be more readily understood from the following detailed description of the invention that is provided in connection with the accompanying drawings and examples.

Some of the applications for the suggested Raman spectroscopic technique include barcodes, label, or other printed material with information stored not only by a specific two-dimensional arrangement of ink like a letter, a figure, a picture, or another symbolic structure, but also by an additional “spectral” dimension defined by the number and ratio of Raman-active substances incorporated in every printed dot or marker.

### DESCRIPTION OF DRAWINGS

FIG. 1 shows Raman spectra of three Raman-active substances: isopropanol, ethanol, and a 20% solution of dimethyl sulfoxide in water measured with the standard portable Raman system (integration time is 1 second). A compact solid state laser (the second harmonics of Nd:YAG, generating the electromagnetic radiation at 532 nm) is used as an excitation source.

FIG. 2 is a table that shows a sample of correspondence between Raman spectra of three element mixtures with text symbols.

FIG. 3 is the sign “Year 2009” constructed with Raman spectra of four different mixtures of three Raman-active substances: isopropanol, ethanol, and water solution of Dimethyl sulfoxide. The spectra are measured with the standard portable Raman system (integration time is 1 second). The laser excitation wavelength is 532 nm.

FIG. 4 is the sign “2009” constructed of Raman spectra of four printed dots or markers of 10 micrometer diameter each. Every dot or marker is printed using different mixtures of two SERRS active substances: a water solution of rhodamine 6G and a water solution of sulforhodamine 101 both incubated with silver nanoclusters. Integration time of Raman spectra is 50 milliseconds.

### DETAILED DESCRIPTION

This invention is in the field of information protection and processing. More particularly it utilizes properties of Raman-active substances to create codes, use such codes for coding information and then read and process such information.

Every printed or otherwise applied dot or marker (the size of which is defined by the spatial resolution of the device designed for reading the said dot) may contain more than a single bit of information.

Printing or otherwise applying dots with Raman-active substances increases this information to a rather large value, which is expressed as:

S=log 2{(a+b−2)!/[(a−1)!(b−1)!]},

where a is the total number of Raman-active substances used to form the said dot, and b is the sampling number which defines the integer number of relative concentrations for each Raman-active substance distinguishable by the reading apparatus with an acceptable error level.

The sampling number is limited by the spectral resolution of the available Raman apparatus as well as the Poisson noise, the reading noise of detector and other factors. In addition, physical conditions such as the finite thickness of Raman spectral bands at room temperature and the overlap of Raman spectral bands for different substances restrict the sampling number b. Similar limitations on the total number of Raman-active substances a also exist. Yet both a and b are substantial even when the Raman spectra are measured with the standard portable Raman setup.

Once a sequence of Raman-active substance dots is printed, for example with an ink jet printer, the following process can be used to translate the printed sequence to text symbols and recover the information stored in the sequence. A Raman scanner, which can be a standard Raman microscope equipped with a laser light source, spectrometer, a translation stage, and a CCD detector focuses on the first dot (i.e. marker) in the sequence and then registers and records the Raman spectrum of the dot. Then, the Raman spectrum is analyzed based on the information stored in a computer to identify (i) the Raman-active substances of the subject dot and (ii) the percentages of each such substance in the subject dot mixture, i.e. the vector of weights. Then, the vector of weights is compared with a reference table in the computer memory, which table provides a correspondence between a weight vector and a symbol or a series of symbols. After identifying the symbol(s) associated with the first dot, the scanner moves to the second dot and so on until the information in the whole sequence is completely read and decrypted.

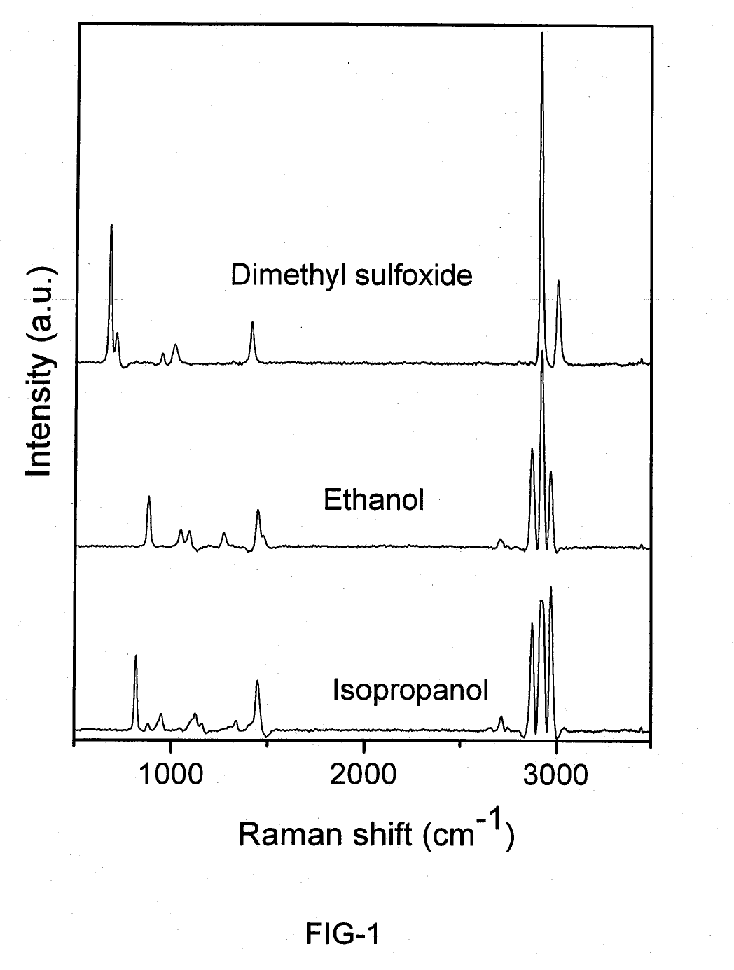

One embodiment of the present invention is demonstrated through FIGS. 1-4. A portable dispersive spectrometer with resolution of 9 cm⁻¹ can be used as a Raman spectroscopic apparatus. The second harmonics of Nd:YAG solid state laser generating the laser beam at wavelength of 532 nm can be utilized as a narrow band excitation source. The latter can be focused on a Raman-active mixture through a system of collimating lenses. The Raman and Rayleigh scattering from the mixture is transferred through the same collimating system to the entrance slit of the spectrometer where the Rayleigh light is cut off by a low pass cut-edge filter. The Raman spectrum is then registered by a CCD camera operating at a room temperature and recorded with a computer.

Three liquids, namely isopropanol, ethanol, and a 20 percent solution of Dimethyl sulfoxide in water have been used by the inventors to form Raman-active mixtures (a=3). A 10% increase or decrease in the concentration of each substance produces a change in the Raman spectrum far above the error level of the experimental setup. The sampling number b is thus equal to 11, i.e. the concentration of one particular substance in the mixture changes from 0 to 100 percent with the 10 percent step.

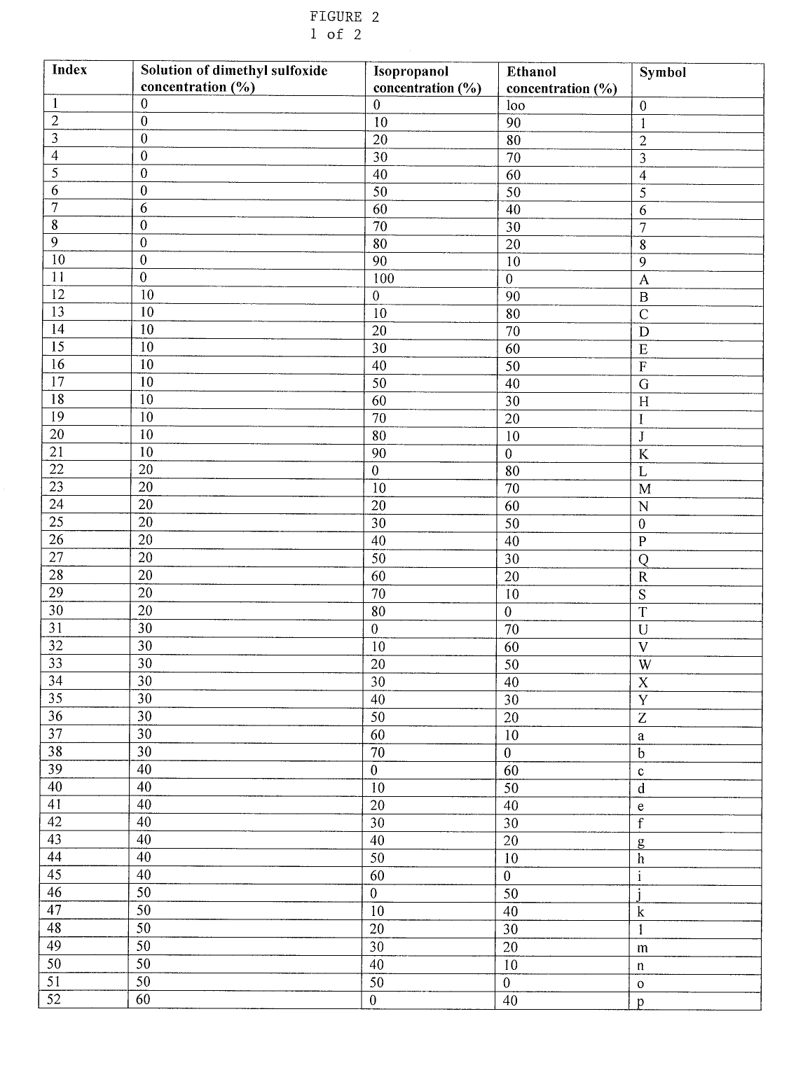

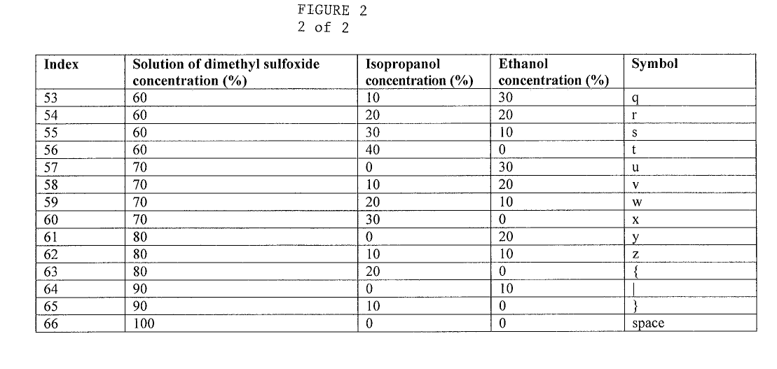

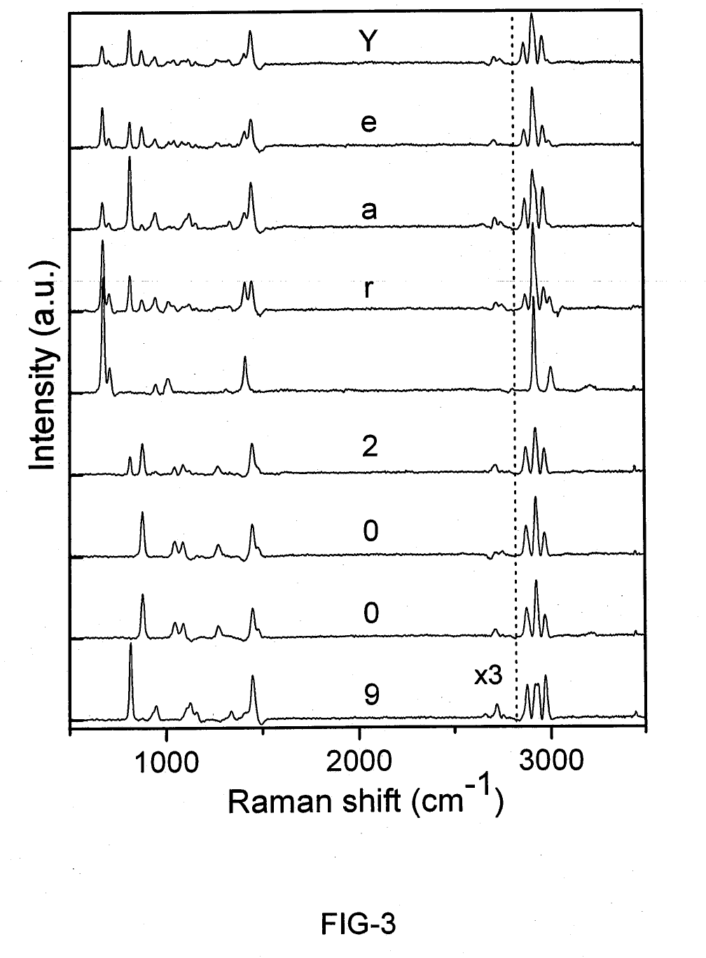

Under these conditions, the stored information in one mixture is enough to code any of the 66 symbols reflected in the table of FIG. 2. The table associates a given mixture with one of the symbols. Thus, the information stored with the use of one particular mixture can be protected by the selection of reference table known only to the developer of the table. This property of storing information with Raman-active substances is especially important for deterring and detecting forgery of commercial labels, barcodes and in many other similar applications. An example of coded encryption constructed with the Raman-active mixtures is presented in FIG. 3. It represents coded symbols that read: “Year 2009”.

With the experimental setup used by the inventors and described above, up to 25 different substances in the mixtures can be spectrally discerned. By utilizing a more elaborate Raman apparatus, the number of substances can be further increased, whereas the sampling number can reach 21 or greater and the information density can exceed 40 bits per dot.

A drawback of the methodology discussed above is a small inelastic light scattering cross section of the mixtures. At least 1 second of accumulation time per a single mixture is necessary to record a Raman spectrum with sufficient noise to signal ratio. It is hardly acceptable for commercial applications. Fortunately, the SERS and SERRS spectroscopic techniques provide large enhancement of the Raman signal, thus making the presented methodology more useful for everyday applications. The SERS technique utilizes roughened surfaces or aggregated colloids of nanoparticles of noble metals like Ag and Au.

The nanoparticles are able to support localized surface plasmons with wavelength in the visible spectral range of electromagnetic radiation. In resonance with an external electromagnetic radiation, plasmons create local electromagnetic field near the surface of nanoparticles thus increasing the inelastic light scattering from the molecules in a close proximity to the surface.

Raman-active substances may be transparent and colored. The transparent substances produce considerably attenuated Raman signals, whereas colored or dyed substances produce stronger Raman signals. Therefore, to further increase the strength of the Raman signal, dyes (including organic dyes) may be used as Raman-active substances. Such dyes are characterized by a well-defined absorption band and, thus, they enhance the intensity of the Raman scattering. Dye molecules have a large inelastic cross section exceeding that of transparent substances by factor of 10³ when the excitation radiation resonates with the molecular electronic transitions.

However, the usage of dyes for the Raman scattering is not straightforward. The luminescence associated with the same electronic transitions, which increases inelastic light cross section, is generally much stronger than the inelastically scattered light.

The SERRS technique overcomes that difficulty. Solutions of dyes are incubated with colloids of silver or gold nanoparticles having surface plasmon resonance in the spectral range of the dye electronic transition. The surface plasmons enhance the light scattered inelastically by transferring the oscillator weight from the luminescence to the inelastic light scattering, i.e., SERRS enhances the inelastic light scattering at the expense of luminescence. The ratio of inelastic light scattering intensity to luminescence intensity is changed by orders of value for the dye molecules attached to the surface of colloid nanoparticles (S. Ni and S. R. Emory, Science 275, 1102 (1997)).

Mixtures of dyes incubated with nanoparticles (i.e., nanoclusters) are perfect candidates for SERRS active mixtures. Nanoparticles of Ag and Au of different sizes with the dispersion of sizes within 5 percent are now commercially available. Thus, preparation of SERRS mixtures is feasible.

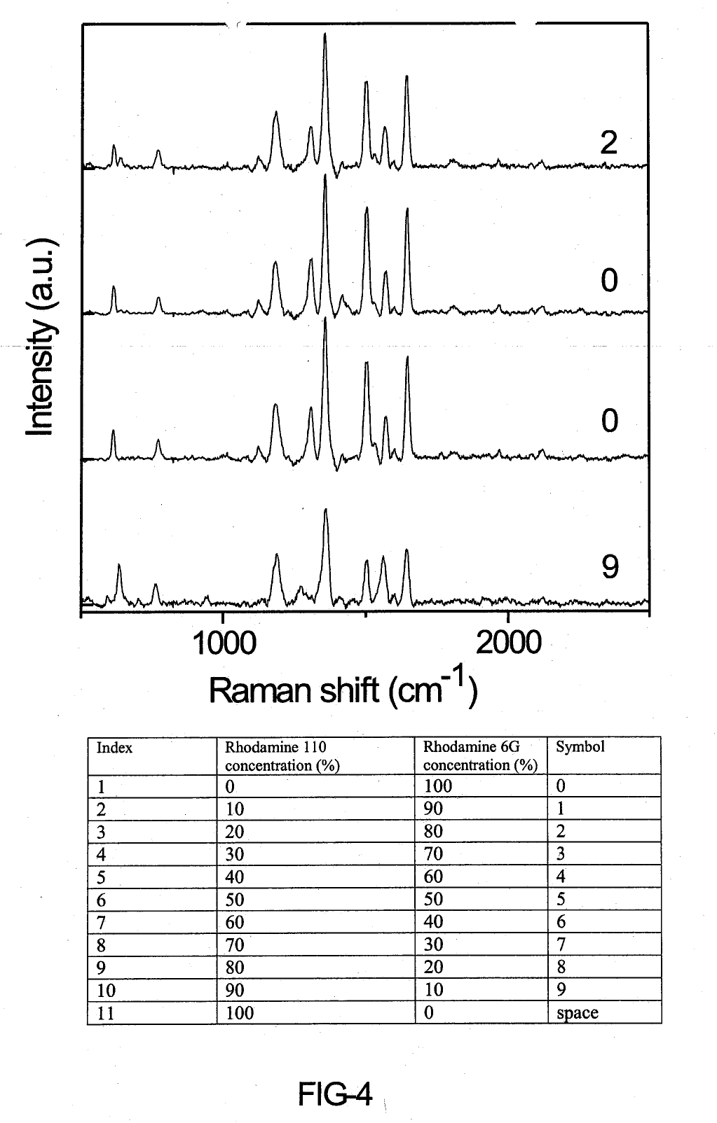

As an example, FIG. 4 illustrates an encryption “2009” constructed of Raman spectra of four printed dots of 10 micrometer diameter each. The dots are constructed of mixtures of two SERRS active substances: a water solution of rhodamine 6G and a water solution of sulforhodamine 101 both incubated with silver nanoclusters.

The nanoclusters are prepared in accordance with the procedure of Lee and Meisel (P. C. Lee and D. J. Meisel, J. Phys. Chem. 86, 3391 (1982)): AgNO₃ can be dissolved in hot water, heated with stirring, and, upon boiling a 1 percent solution of sodium citrate can is added. Though the nanoclusters had a large dispersion of spatial dimensions, the SERRS enhancement is significant. The accumulation time required to obtain a Raman spectrum of a single dot can be decreased to the millisecond range.

The above examples demonstrate the potential of Raman spectroscopy and SERRS active mixtures for information coding, storing, and processing. The amount of information stored and recovered with commercially available printing and Raman spectral apparatus is already significant (above 40 bits in a single dot). A standard Raman microscope equipped with a two-dimensional translation stage can supply the spatial resolution sufficient to resolve two nearest dots spatially separated by 5 micrometers. That provides for density of highly protected information of more than 1 megabit per square millimeter.

It should be understood that the above examples and data are presented only for purposes of clarity and illustration. It is not intended to be exhaustive or to restrict the invention to the precise disclosed examples. Therefore, it must be understood that many modifications and variations are possible. Such modifications and variations are intended to be included within the scope of the appended claims.

What we claim is:

1. A method comprising steps of:
selecting at least two Raman-active substances,
preparing at least one mixture of said Raman-active substances, and
associating each of said at least one mixture with a unique symbol.

2. The method of claim 1, wherein said unique symbol is one of a set of symbols.

3. The method of claim 1, further comprising a step of using said at least one mixture as a marker for identifying at least one subject.

4. The method of claim 1, further comprising a step of using a plurality of said mixtures to apply a plurality of markers to said at least one object, wherein said plurality of markers may contain unlimited amounts of information.

5. The method of claim 1, wherein at least one mixture comprises at least one colored Raman-active substance.

6. The method of claim 1, wherein at least on mixture comprises a plurality metal nanoclusters.

7. The method of claim 1, further comprising a step of assembling a reference table that correlates each of said mixtures with a unique symbol.

8. The method of claim 4, wherein said plurality of markers are applied to said at least one object with an ink jet printer.

9. A method comprising steps of:
directing a laser light source on at least one Raman-active marker located on an object;
applying radiation from said laser light source to said at least one Raman-active marker located on said object,
registering a radiation spectrum, as reflected from said at least one Raman-active marker on said object, and
identifying a symbol that corresponds to said radiation spectrum as reflected from each of said at least one Raman-active marker on said object.

10. The method of claim 9, further comprising a step of calculating percentages of each Raman-active substance contained in each of said Raman-active marker.

11. The method of claim 10, further comprising steps of:
comparing said percentages of each Raman-active substance with a table of percentages stored in a computer; and
correlating said percentages of each Raman-active substance with a symbol contained in said table.
